(19) United States
(12) Patent Application Publication
(10) Pub. No.: US 2022/0411264 A1
(43) Pub. Date: Dec. 29, 2022

(54) METHODS, PROCESSES AND SYSTEMS FOR THE PRODUCTION OF HYDROGEN & CARBON FROM WASTE, BIOGENIC WASTE AND BIOMASS

(71) Applicants: Robert T. Do, Potomac, MD (US); Sylvain André Luc Motycka, Washington, DC (US)

(72) Inventors: Robert T. Do, Potomac, MD (US); Sylvain André Luc Motycka, Washington, DC (US)

(21) Appl. No.: 17/809,871

(22) Filed: Jun. 29, 2022

Related U.S. Application Data
(60) Provisional application No. 63/216,012, filed on Jun. 29, 2021.

(51) Int. Cl. C01B 3/24; C01B 3/56; C09C 1/48; B01J 6/00

(52) U.S. Cl. CPC C01B 3/24; C01B 3/56; C09C 1/485; B01J 6/008; C01B 2203/0272; C01B 2203/0861; C01B 2203/1241; C01B 2203/042

(57) ABSTRACT

Provided herein are novel devices, systems, and methods of using the same, that enable plasma-enhanced pyrolysis of biogenic waste material comprising pyrolysis systems including primary tuyeres for introduction of natural gas directly to a molten lava bed, one or more plasma torches for introducing inert gas into the system, together with mechanisms for capture and collection of combustion products including, but not limited to, turquoise hydrogen and carbon black.

### CROSS-REFERENCE TO RELATED PATENT APPLICATIONS

The present application claims priority to and all the benefits of U.S. Provisional Patent Application No. 63/216,012, filed on Jun. 29, 2021, which is hereby expressly incorporated herein by reference in its entirety.

### FIELD OF THE INVENTION

Embodiments of the present disclosure relate to methods, processes, and systems for the manufacture of high purity hydrogen and carbon black from biomass waste. Included herein are methods, processes, and systems wherein biomass waste, such as biogenic hydrocarbon waste, is introduced into a pyrolysis system, and wherein the pyrolysis system comprises a unique system of tuyeres, molten lava bed and plasma torches. The pyrolysis systems described herein enable the production of high purity hydrogen and carbon black.

### BACKGROUND OF THE INVENTION

Studies from the United Nations (UN), Intergovernmental Panel on Climate Change (IPCC), and Environmental Protection Agency (EPA) and other public organizations confirm that worldwide energy requirements are becoming a serious and crucial issue because consumption is increasing at alarming rates due to increasing population and industrialization. Unfortunately, most of the world's energy is produced from the combustion of coal, oil or natural gas, which has been proven to result in the alarming rise of greenhouse gases, subsequent global warming and climate change.

One clear and indisputable solution to the above issues is the development of green and renewable energy sources. The need for such solutions has resulted in the rapid growth of wind and solar energy technology development worldwide. However, at least one drawback of relying on wind and solar energy is that these energy sources are intermittent in nature, as well as geographically and weather dependent. Importantly, they create several other major complications, including but not limited to: the failure to address the 40% of energy usage for transportation/mobility, production of imbalance and instability in the power grid, difficulties related to storage of large quantities of power, inconsistent and seasonal power production; lack of contribution to the decarbonization of infrastructure (such as natural gas pipelines); and inability to generate high heat required in large industries such as cement or steel mills.

The mobility and transportation industry is mostly dependent on petroleum based liquid fuel such as gasoline, diesel and kerosene, and demand for such fuels is growing rapidly due to increasing population growth and increasing travel. With the development of an integrated worldwide economy, the fuel needs of the aviation and shipping industry in particular are increasing exponentially. Agriculture based bio-fuels such as bio-ethanol and bio-diesel have not been able to provide measurable changes in greenhouse gas (GHG) reduction and have contributed to conflicts based food versus fuels.

With the successful commercialization of electric vehicles, there has significant progress in the development of electric motors. The electricity can be delivered to the vehicles using batteries to provide stored electricity in the vehicles; however, batteries are suboptimal for a variety of reasons including the fact that they are typically large and heavy, take a long time to charge (mostly from non-renewable electric sources), and have limited ranges (over less than 200 miles per charge). Electric battery vehicles (EBV) have difficulty in meeting requirements for long haul vehicles such as trucks, buses, trains and ships. With the advancement and commercialization of fuel cell systems, electricity can be delivered to the vehicles via hydrogen which can be stored and converted into electricity via the fuel cell systems. Hydrogen fuel cell electric vehicles (FCEV) are becoming the zero emission vehicle of choice for major car manufacturers due to a hydrogen tank/fuel cell stack which is both compact and lightweight, which is capable of instant charging or fueling within few minutes, and also has the capacity to provide enough electricity for ranges up to 500 miles. similar to gasoline/diesel fueled vehicles.

The concept of green hydrogen and utilizing hydrogen to address the world's energy needs and problems was introduced as a “simple solution” by American biochemical engineer, Patrick Kenji Takahashi. Hydrogen is the simplest element on the periodic table and the most abundant in the universe. It is always found combined with other elements and must be separated from hydrocarbons (e.g., methane CH₄) or water (H₂O) for use as an energy carrier. When energy is generated from renewable sources like solar, wind and geothermal, electricity is consumed as it is produced. Electrolysis involves passing an electric current through water (H₂O), which causes it to split into hydrogen (H) and oxygen (O). This process can be carried out either through an energy grid or on-site. Separated hydrogen may then be stored in a pressurized tank for future use. Stored hydrogen can be subsequently sent to fuel cells where it is recombined with oxygen and converted to a usable source of power for a variety of uses such as for generating heat or fueling transportation. Using renewable electricity can reduce dependence on fossil fuels and extend the reach of wind and solar power beyond the confines of the electric grid.

Renewable hydrogen is a viable and important solution for current and future energy problems. It is a source of zero carbon renewable energy that can supply the electricity used in the electrification of the transportation/mobility sector in lieu of petroleum based liquid fuel. Renewable hydrogen be injected into natural gas pipelines to decarbonize natural gas grids and downstream power plants, provide high quality heat required in factories (such as cement plants to reduce usage of coal and coke), be used as reducing agent in steel mills to produce high purity iron. Furthermore, renewable hydrogen can be easily stored in large quantities as a source of renewable energy unlike the cumbersome bulk and inefficiencies of batteries.

What is needed is the large-scale production of renewable green hydrogen that can be accomplished efficiently and with minimal greenhouse gas emissions. As noted above, current methods for producing renewable hydrogen using 100% renewable power involves the electrolysis of water. This process however is not optimal for a variety of reasons. Importantly, the process is prohibitively expensive when conducted on a large scale due to the dependency on renewable power (which is oftentimes intermittent), and also due to the requirement of a high amount of electricity (approximately 62 kWh to generate 1 kg of H₂). In addition, there is a substantial cost associated with the use of deionized water, approximately 8 gallons of deionized water is necessary for producing 1 kg of H₂. Further, the capacities of currently available electrolyzers are inadequate as they are useful for small scale production only. It is possible that the price of H₂ production from electrolysis may reduce over time with the building of large offshore wind farms, perhaps accompanied by decreased costs of electrolyzers when and if large scale systems are developed. In the meantime however, what is necessary are immediate solutions to satisfy current and future demands for low cost, green hydrogen; ideally, such solutions should be cost-effective, easy to implement and require minimal investment in the development of new infrastructure.

Viewed both from an economic and technical perspective, it should be recognized that gasification of abundantly available biomass and waste materials to produce renewable hydrogen could be a cost effective way to supply the hydrogen required for FCEV (fuel cell electric vehicles) and for several other uses. Indeed, the overall thermal efficiency of converting hydrogen to electric energy required by an FCEV is three times higher than the burning of that liquid fuel to power the combustion engine vehicles used today. Utilizing hydrogen in this way may contribute significantly to global energy security.

Worldwide, increasing amounts of biomass, whether municipal or industrial biomass, agricultural residues or industrial byproducts etc., are either dumped or remain unexploited, while releasing methane in the atmosphere. The impact of methane is estimated to be 28 to 36 times more harmful to the environment than carbon dioxide over 100 years according to the EPA. Furthermore, due to poor waste management methods in the past decades along with polluting energy production technologies (such as burning coal) there are continual increases in carbon dioxide and greenhouse gases emissions resulting in worsening global life cycle assessment.

Biomass including waste is also burned in common incinerators, creating emissions of pollutants, including carcinogenic materials such as semi-volatile organic compounds (SVOCs), dioxins, furans, etc., which are products of low temperature combustion. For the last couple of decades, developed nations such as the United States, Japan and European countries have been recycling their mixed plastics and mixed paper, totaling over 100 million tons per year, most of which are then exported to China for reuse in lower value products. This practice was halted by the Chinese government as of Jan. 1, 2018 resulting in millions of recycled materials being stored and/or sent back to landfills.

The need for systems and processes which include devices and apparatuses to handle and treat various forms of waste, biomass and recycled materials such as mixed plastics and mixed papers as well as converting these feedstocks into renewable synthetic gas to serve as a source of readily renewable electrical energy, has been met in part by the apparatus and processes disclosed and claimed in U.S. Pat. Nos. 5,544,597 and 5,634,414 issued to Camacho. These patents disclose a system in which biomass or other organic material is compacted to remove air and delivered in successive quantities to a reactor having a hearth. A plasma torch is then used as a heat source to pyrolyze organic components, while inorganic components are removed as vitrified slag.

More recently, improvements to the apparatus and processes of the above patents for pyrolysis, gasification and vitrification of organic material, was disclosed in U.S. Pat. No. 6,987,792 to Do et al. This patent provides an improved material feeding system in order to enhance further the efficiency of the process as well as to increase the flexibility of the system, increase the ease of use of the material handling system, and allow the gasifier to receive a more diverse and varied material stream.

The apparatus and process of U.S. Pat. No. 6,987,792 ensures that high temperature is maintained in the bed zone through the use of plasma torches in conjunction with a catalyst bed. Additionally, the patent discloses several rings of tuyeres designed and located at different elevations of the bed to inject, for example, oxygen enriched air from the sides of the reactor to its center in order to maintain high temperatures and an efficient and complete gasification condition along the overall cross sections of the gasifier, while observing sub-stoichiometric conditions. The oxygen utilized in the U.S. Pat. No. 6,987,792 is supplied by a secondary source and is not produced integrally within and by the system.

Biomass as processed by the above-described systems generates hydrogen, however other byproducts of the process also warrant collection and repurposing. For example, one byproduct is carbon black. Carbon black may comprise any of a group of intensely black, finely divided forms of amorphous carbon, usually obtained as soot from partial combustion of hydrocarbons, and may be used for many purposes including as reinforcing agents in automobile tires and other rubber products, as pigments, UV stabilizers, and conductive or insulating agent in a variety of rubber, plastic, ink and coating applications.

Though the previously described systems and processes are useful, they represent early attempts for biomass gasification for purposes of production of renewable power and renewable liquid fuels rather than for renewable hydrogen production. These systems also fail to address the need for efficient production of carbon byproducts such as carbon black. As described above, current energy demands and fuel-based industries require access to green renewable hydrogen and renewable energy in an increasingly cost-effective and time efficient manner.

What is needed therefore, are efficient systems, processes and methods for the pyrolysis of biomass to produce renewable green hydrogen such that the hydrogen is available for use, for transportation, and for other industrial applications. What is also needed, are systems that effectively process natural gas for the production of carbon byproducts. Preferably such systems, processes and methods should be easy to implement, cost-effective, efficient, reliable and compatible with the energy needs of the modern world.

### SUMMARY OF THE INVENTION

Provided herein are novel methods and systems comprising proprietary pyrolysis procedures for the production of hydrogen (H₂), including but not limited to, green, brown, grey, white and turquoise renewable H₂ worldwide. Hydrogen is considered to be an important component for meeting the world's energy needs, as well as the world's decarbonization needs.

Provided herein are methods, devices and systems for plasma-enhanced pyrolysis of waste material comprising the use of novel pyrolysis units and systems. As contemplated herein the pyrolysis units and systems of the invention comprise a unique system of tuyeres, molten lava beds and plasma torches that enable the production of high purity hydrogen and that also enable efficient cracking of natural gas to produce carbon black.

In previous embodiments of process reactor systems emphasis was placed on the generation and collection of hydrogen due to the process that was optimized for gasification systems, therefore, no specific accommodation was made with regard to collecting other byproducts of resulting from the pyrolysis reactions therein. In an effort to eliminate the aforementioned deficiencies, and in an effort to create streamlined, cost-effective and operationally superior systems and processes, the novel invention as described herein provides unique features which comprise the design of primary tuyeres for introducing natural gas, whether fossil-sourced or from landfill gas, into a molten lava bed such that the natural gas is instantly cracked and separated into gaseous hydrogen and carbon black, also provided herein are plasma torches and collection mechanisms to accomplish effective processing and repurposing of both hydrogen and byproducts such as carbon black.

In an embodiment, the apparatus described and referred to as a pyrolysis system, contains, plurality of plasma arc torches that are mounted in the lower section to heat the molten lava bed. The system further includes primary tuyeres for introducing natural gas into a molten lava bed such that the natural gas is instantly cracked and separated into gaseous hydrogen and carbon black.

In certain embodiments, the methods and processes of the invention are executed in the absence of oxygen, and without gasification.

Other features and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a schematic showing a representative design for the pyrolysis systems described herein. W represents the area from where silica is introduced to form a lava bed, F7 is where clean H₂ gas is extracted, F4 is represents a primary tuyere through which natural gas (methane) and plume from a plasma torch are inserted.

FIG. 2 provides a block flow diagram of a MPTRH2 production facility.

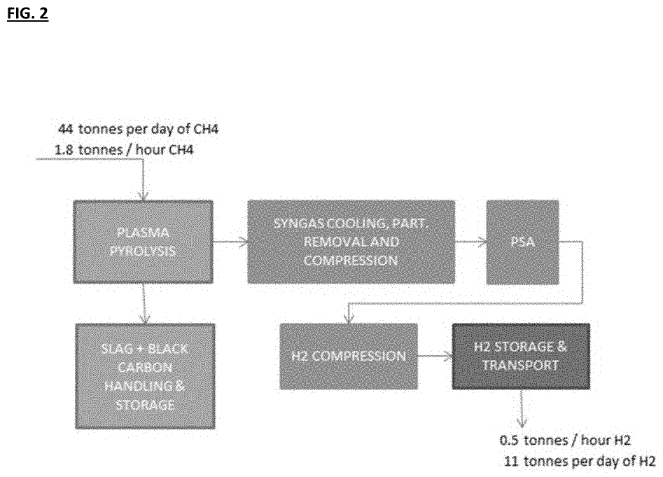

### DETAILED DESCRIPTION

The present invention is described with reference to particular embodiments having various features. It will be apparent to those skilled in the art that various modifications and variations can be made in the practice of the present invention without departing from the scope or spirit of the invention. One skilled in the art will recognize that these features may be used singularly or in any combination based on the requirements and specifications of a given application or design. One skilled in the art will recognize that the systems and devices of embodiments of the invention can be used with any of the methods of the invention and that any methods of the invention can be performed using any of the systems and devices of the invention. Embodiments comprising various features may also consist of or consist essentially of those various features. Other embodiments of the invention will be apparent to those skilled in the art from consideration of the specification and practice of the invention. The description of the invention provided is merely exemplary in nature and, thus, variations that do not depart from the essence of the invention are intended to be within the scope of the invention.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Unless otherwise defined, all technical and scientific terms used herein have the same meaning as would be commonly understood or used by one of ordinary skill in the art encompassed by this technology and methodologies.

Texts and references mentioned herein are incorporated in their entirety, including U.S. Pat. Nos. 5,544,597, 5,634,414, 6,987,792, PCT/US14/15734, U.S. patent application Ser. No. 13/765,192, U.S. patent application Ser. No. 17/474,729, PCT application filed PCT/US14/15792, and U.S. Pat. No. 9,206,360.

The novel invention provided herein comprises devices, systems, and methods of using the same, that enable pyrolysis of materials, such as biomass, to produce hydrogen gas and other byproducts. As contemplated herein, the term biomass is intended to encompass any biomaterial and is used interchangeably with the term feedstock. In certain embodiments, biomass may include, but is not limited to, waste, re-cycled paper, organic waste, purposely grown energy crops, wood or forest residues, waste from food crops, horticulture, food processing, animal farming, human waste from sewage plants or industry waste.

At least one advantage of the invention is that the use of biomass provides the benefits of both reducing greenhouse gases and carbon footprint by producing a biomass derived syngas (bio-syngas) for the production of renewable hydrogen and biogenic carbon dioxide. The produced renewable hydrogen and biogenic syngas can be further processed to produce renewable power through a variety of methods and devices known to those skilled in the art, including but not limited to, hydrogen fuel cell batteries, proton exchange membrane fuel cells (PEM FC) or solid oxide fuel cells (SOFC) providing a complete off grid distributed renewable power system to facilities, vehicles, and the like that require energy. The renewable hydrogen and biogenic carbon dioxide produced herein can also be recombined through a mechanization process to produce renewable methane gas for use in gas pipelines instead of natural gas. The renewable hydrogen and/or biogenic carbon monoxide can be use as feed gas to create transportation fuels such as ammonia, synthetic methane a.k.a. renewable natural gas (RNG), renewable methanol, synthetic paraffinic kerosene and renewable liquid fuels to replace gasoline and diesel in the transport sector. The natural gas can be optionally be processed via specialized plasma pyrolysis systems comprising the use of a specialized molten lava bed (or catalyst bed) that enables cracking of the natural gas to produce carbon black. Furthermore, the methods and processes described herein may work with any organic hydrocarbon containing waste material.

In certain embodiments of the invention, the hydrogen generated according to the methods described herein may be delivered to a fueling station by truck or pipeline under pressure as compressed hydrogen gas, and stored at suitable conditions (most typically in one or more underground storage tanks. Hydrogen is then withdrawn from the storage tank/tanks in continuous manner or on demand and recompressed to the desired pressure required by the fuel cell vehicles as required.

A single stage atmospheric pressure thermocatalytic plasma enhanced vessel may be used in accordance with the invention and may be configured to process from 5 to 20 metric tons per hour of mixed sources of organic waste and/or biomass, although vessels sized larger or smaller may be used. The exact throughput will depend on the composition of the feed material and the desired overall throughput of the generating plant. The vessel of the present disclosure can be distinguished from other plasma gasification systems by the fact that it is designed with a primary tuyere for introducing natural gas into a molten lava bed such that the natural gas is instantly cracked and separated into gaseous hydrogen and carbon black. Plasma torches for introducing inert gas, such as nitrogen or carbon dioxide, to produce a plasma plume to enable the production of high purity hydrogen and other byproducts such as carbon black are used in connection with the vessels described herein.

In certain embodiments, the pyrolysis systems claimed herein include an a unique biochar catalytic bed. In an embodiment, the biochar comprises mainly carbon derived from char generated from biomass pyrolysis. Additional materials are mixed with the biochar into the vessel such as flux materials comprising silica and calcium oxide (typically in the form of limestone). The composition of the biochar is customized to address specific gasification, pyrolytic and vitrification process operating conditions.

In an embodiment, the biochar carbon catalyst bed is designed to ensure consistent plasma heat distribution across the cross-section of the reactor as a result of its high fixed-carbon content in contrast to the high volatile matter content of the feedstock (biomass and waste materials). In contrast to currently available fixed bed gasifiers, the biochar carbon catalyst's even heat distribution helps prevent the channeling of heat through the feedstocks bed or the formation of melted frozen plug (dead body plug) within the feedstocks typically encountered with fixed bed gasifier.

As demonstrated in earlier patents listed above, the inventors herein previously developed a unique system of Upcycling Waste to H₂ (UWTH2) solution utilizing a proprietary plasma enhanced gasification system to convert low-value hydrocarbon products (waste/biomass residue) into higher value renewable hydrogen. The inventors' novel UWTH2 system comprised a thermal catalytic conversion (high temperature, fixed-bed, counter current gasification) process utilizing plasma arc torches to increase the temperatures of fixed bed gasifiers in order to optimize the efficiency of producing syngas and hydrogen from difficult to handle feedstocks such as waste, recycled mixed plastics and tires.

As described herein, the inventors have discovered and created novel embodiments of plasma pyrolysis systems that are designed, modified and operated in a pyrolytic mode utilizing plasma heat generated from allothermal plasma torches to crack hydrocarbon materials, including gaseous hydrocarbons such as methane (CH₄), under endothermic conditions. The methane gas undergoes pyrolysis in a reducing environment at plasma temperature of greater than 3000 degrees Celsius and is thermally cracked in the plasma molten zone into a gaseous hydrogen and pure carbon black. The pure carbon black is separated and sequestered (or captured) for use as feedstocks in industrial facilities. The pure hydrogen may be collected and exported as renewable hydrogen, including for example, as “TURQUOISE H2”.

Currently, the only completely zero carbon fuel that has the capacity to replace liquid petroleum products in the transport sector is hydrogen, either in gaseous form or in liquid form. As noted above, with the advancement and commercialization of fuel cell based transportation systems, hydrogen is becoming the fuel of choice for major car manufacturers due to its (1) compact and lightweight, (2) fast charging/fueling within few minutes, and (3) capacity to provide enough electricity for ranges up to 500 miles similar to gasoline/diesel fueled vehicles. As an energy carrier, hydrogen has an energy density of 40 kWh/kg, diesel and LPG at 13 kWh/kg and battery at just 0.05 kWh/kg which makes battery 800 times less favorable than hydrogen per kg as an energy carrier. Further, it should be appreciated that in order to meet the definition of green or renewable hydrogen (RH2), the hydrogen must be produced with zero greenhouse gas emissions.

With the advance and successful commercialization of fuel cell technology, hydrogen can provide instant power for electric vehicles providing long ranges, lighter and more efficient vehicles without the need for bulky and heavy batteries. A Fuel Cell Vehicle (FCV) with a H₂ tank and a Fuel cell pack*which weighs 80 kg) can be charged with 5 kg go H₂ in 3-4 minutes and has a range of up to 500 miles; a Tesla S (Electric Battery Vehicle) has a battery that weighs 550 kg, takes 5 hours to charge and has a range of 220 miles. Some of the largest car manufacturers such as Toyota, Audi, Hyundai, BMW, Honda, Volkswagen and Mercedes Benz have all committed to stop producing combustion gas engines (CGE) by 2030, and are focusing on the development of FCVs with hydrogen as the fuel of choice over batteries. Similarly, top oil companies such as Shell and Chevron have adopted H₂ as the future fuel of choice and are installing H₂ fueling pumps at their respective gas stations worldwide, staring in California, the United Kingdom and Germany.

Today almost 95% of the hydrogen produced is “Grey” Hydrogen, so named because it is generated from fossil fuels—especially natural gas and coal. Several decarbonization pathways exist, including blue hydrogen (capturing carbon emissions at the point of production) and green power-to-gas (generating hydrogen with an electrolyzer), driven by renewable electricity.

However, the above-described decarbonization pathways have heretofore faced severe challenges: (A) to produce blue or turquoise hydrogen by capturing carbon emissions requires the utilization of technology of carbon capture coupled with the challenge of the disposition of the captured CO2 in a cost efficient manner; (B) green power-to-gas or electrolytic hydrogen is considered green only if renewable energy such as solar and wind are used; however the process still faces several key challenges: (i) intermittent production (ii) high intense parasitic load (iii) high costs of solar and wind electricity (iv) limitation of electrolytic equipment capacity making the production of green renewable electrolytic hydrogen very expensive. A strong candidate for the production of renewable hydrogen that can be accomplished at large scale is the conversion of biogenic fraction of municipal solid waste as renewable feedstocks into renewable hydrogen.

There are significant disadvantages associated with certain types of hydrogen. For example, brown hydrogen produced from natural gas has a very heavy carbon footprint: production of one ton of brown hydrogen requires 3 tons of natural gas and generates ten tons of carbon dioxide. Generating green hydrogen by electrolysis requires large amounts of water and renewable electricity, making the production cost prohibitive.

A novel alternative that in many ways sits somewhat between blue and green hydrogen is ‘methane pyrolysis’— turquoise hydrogen. Like grey and blue hydrogen, turquoise hydrogen also uses methane as a feedstock, but the process is driven by heat produced with electricity rather than through the combustion of fossil fuels. Like blue and grey hydrogen, methane pyrolysis produces hydrogen and carbon as outputs, however, unlike SMR (steam method reforming), the carbon is in solid form rather than carbon dioxide. As a result, there is no requirement for CCS (carbon capture and storage) and the carbon can even be used in other applications, such as a soil improver or the manufacturing of certain goods such as tires. Where the electricity driving the pyrolysis is renewable, the process is zero-carbon, or even carbon negative if the feedstock is biomethane rather than fossil methane (natural gas).

In accordance with the methods described and claimed herein, producing turquoise hydrogen using natural gas, such as methane allows for the capture of approximately 100% of the carbon in the form of carbon black/carbon graphite. In addition, a further advantage of the current methods is that turquoise hydrogen replaces grey hydrogen from SMR, and therefore can avoid/displace 12 tons of CO2 generating approximately 16 tons of CO2 per ton of turquoise H₂ produced.

As described and claimed herein, the inventors' methods comprising the use of very high operating temperatures (produced by proprietary plasma arc torches systems) allow for the effective cracking of methane bonds in a molten lava state enabling complete separation of gaseous hydrogen from solid carbon. In addition, the methods and systems employed avoid the mixing of carbon formation in vapor state (accordingly the requirement of expensive separation system from gaseous hydrogen products is negated). Features such as atmospheric pressure operation and a modular system design, allow for simple operation, lower operating costs, stream-lined construction and maintenance. Furthermore, the use of proprietary and non-metallic molten materials allows for re-use and decreases the loss of carbon black in the form of metallic carbon. Overall, because of base load operation, the cost of producing high purity hydrogen, such a turquoise hydrogen, is significantly reduced.

In an embodiment, provided herein are methods for producing high purity hydrogen and carbon black comprising the use of a pyrolysis system, wherein the pyrolysis system comprises the use of a reactor capable of operating under pyrolytic conditions without the use of oxidizing agents. The pyrolysis system generally comprises (1) primary tuyeres for introducing natural gas into a molten lava bed such that the natural gas is instantly cracked and separated into gaseous hydrogen and carbon black, and (2) plasma torches for introducing inert gas, such as nitrogen or carbon dioxide, to produce a plasma plume.

The pyrolysis system is designed such that the hydrogen rises through the molten lava bed into the reactor and exits at the top of the reactor as exit gas, where it is cooled, compressed, separated and purified; and such that the carbon black rises to the top of the lava bed for collection and repurposing. The system produces high purity hydrogen including but not limited to turquoise hydrogen, blue hydrogen, green, white hydrogen and/or combinations thereof. In certain embodiments, the exit gas may be cooled, compressed, separated and purified using a pressure swing absorber system. Furthermore, the carbon black includes, but is not limited to, carbon graphite, acetylene black, channel black, furnace black, lamp black or thermal black. In certain embodiments, the carbon black may be separated outside the reactor when the molten materials are cooled and hardened.

In an embodiment, the plasma pyrolysis system includes only primary tuyeres, and does not include secondary or tertiary tuyeres. In alternative embodiments, the plasma pyrolysis system includes primary, secondary and teritiary tuyeres. In certain embodiments, primary tuyeres are used to introduce natural gas into the molten lava zone. In certain embodiments, primary tuyeres are used to introduce natural gas into the molten lava zone via injection underneath the molten lava bed. In certain embodiments, primary tuyeres are used to introduce methane gas into the molten lava zone. In certain embodiments, primary tuyeres are used to introduce purified clean methane gas into the molten lava zone.

In certain embodiments, the molten lava bed comprises silicate-based materials optimized to produce a molten lava bed having desired temperature and viscosity. In certain embodiments, the molten lava bed is comprised of proprietary silicate-based materials created by SGH2 Energy Global LLC (Washington, DC USA) optimized to support rapid cracking of natural gas (including methane) and to enable the production of high purity hydrogen and carbon black. In certain embodiments, the molten lava bed does not contain any metallic materials and is maintained by plasma torch plumes placed around the base of the reactor. The plasma torches may be placed concentrically, or in any other arrangement around the reactor. The system may include any number of necessary plasma torches, for example it may include 1-3, 1-4, 1-5, or 3 plasma torches placed around the base of the reactor. In an embodiment, the system consists of three plasma torches placed concentrically around the base of the reactor. In certain embodiments, silicate molten materials may be recycled.

Provided herein are methods for producing high purity hydrogen and carbon black comprising the use of a plasma pyrolysis system, wherein the pyrolysis system comprises the use of a reactor capable of operating under pyrolytic conditions without the use of oxidizing agents, wherein the pyrolysis system comprises: (1) primary tuyeres for introducing methane into a molten lava bed such that the methane is instantly cracked and separated into gaseous hydrogen and carbon black, and (2) plasma torches for introducing inert gas, such as nitrogen or carbon dioxide, to produce a plasma plume wherein the hydrogen rises through the molten lava bed into the reactor and exits at the top of the reactor as exit gas, and wherein the exit gas is cooled, compressed, separated and purified; and wherein the carbon black rises to the top of the lava bed and is collected.

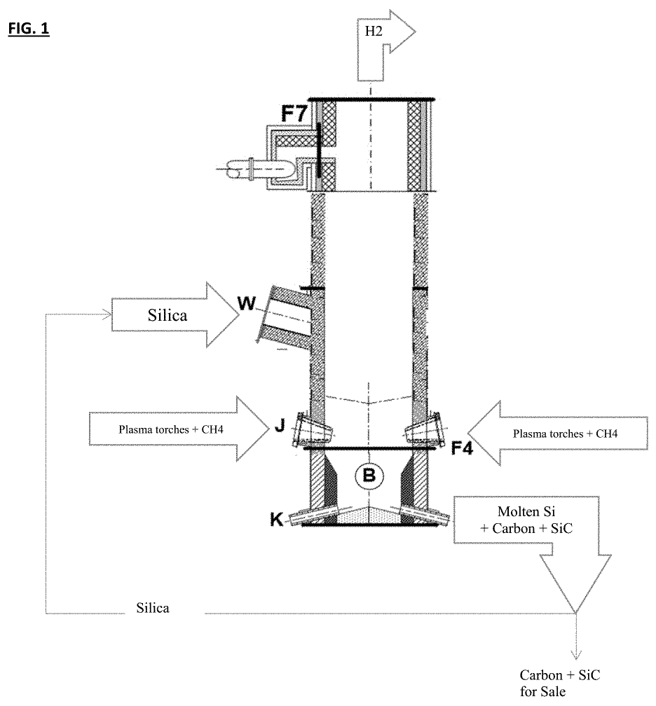

The pyrolysis systems described herein may also be referred to as plasma enhanced pyrolysis systems. The systems are designed to enable pyrolysis of feedstock at high temperatures: the plasma pyrolysis systems comprise high temperature, fixed-bed counter current pyrolysis utilizing plasma arc torches for increasing temperatures of fixed bed pyrolytic vessels. In certain embodiments the novel pyrolysis systems claimed herein enable pyrolysis of methane in a reducing environment at temperatures greater than 3000 degrees Celsius. In certain embodiments, the plasma pyrolysis systems utilized in accordance with the invention resemble the system shown in FIG. 1.

Biomass and Biomass Feeding System

A compacting biomass delivery system operating through hydraulic cylinders and/or screws to reduce the biomass volume and to remove air and water in the biomass prior to feeding into the top of the bed zone as previously described and disclosed in the above identified Solena Fuels Corporation patents can be employed.

In order to accommodate biomass and biomass-residues, organic renewable feed stocks biomass from multiple and mixed sources such as RDF (refuse-derived fuel), loose municipal solid waste (MSW), industrial biomass, and biomass stored in containers such as steel or plastic drums, bags and cans, a very robust feeding system can be used. Biomass may be taken in its original form and fed directly into the feeding system without sorting and without removing its containers. Biomass shredders and compactors capable of such operation are known to those of ordinary skill in the field of materials handling. Biomass feed may be sampled intermittently to determine its composition prior to treatment.

Biomass includes, but is not limited to, non-fossilized and biodegradable organic material originating from plants, animals and micro-organisms. Also included are products, by-products, residues and waste from agriculture, forestry and related industries as well as the non-fossilized and biodegradable organic fractions of industrial and municipal wastes. Biomass also includes gases and liquids recovered from the decomposition of non-fossilized and biodegradable organic material. (b) Biomass residues means biomass by-products, residues and waste streams from agriculture, forestry and related industries.

All the biomass and organic material, optionally including the containers in which it is housed, is crushed, shredded, mixed, compacted and pushed into the plasma reactor as a continuous block of waste by a system (not shown). The biomass can be comminuted to a preset size to insure optimal performance of the vessel used for pyrolysis. The feeding rate can also be preset to ensure optimum performance of the vessel.

Operating Principles

In general, the plasma pyrolysis apparatus and process described herein functions and operates according to several main principles.

Variations in the biomass feed will affect the outcome of the process and will require adjustment in the independent control variables. For example, assuming a constant material feed rate, a higher moisture content of the biomass feed will lower the exit top syngas temperature; the plasma torch power must be increased to increase the exit syngas temperature to the set point value. Also, a lower hydrocarbon content of the biomass will result in reduction of the carbon monoxide and hydrogen content of the exit gas resulting lower high heating value (HHV) of the exit top syngas; the enrichment factor of the inlet gas and/or plasma torch power must be increased to achieve the desired HHV set point as well as the desired volume of hydrogen. In addition, a higher inorganic content of the biomass will result in an increase in the amount of slag produced resulting in increased slag flow and decreased temperature in the molten slag; the torch power must be increased for the slag temperature to be at its target set point. Thus, by adjusting various independent variables, the vessel can accommodate variation in the incoming material feed while maintaining the desired set points for the various control factors. The present disclosure further includes the proprietary aspect that the above process algorithm will be controlled via a distributed control system (DCS) equipped with artificial intelligence (AI) allowing for the automatic adjustment and optimization of the process to maximize the production of renewable hydrogen and its downstream applications including the generation of synthetic methane or synthetic liquid fuels.

Start-Up

The goal of a defined start-up procedure is to create a gradual heat up of the vessel to protect and extend the life of the equipment of the vessel, as well as to prepare the vessel to receive the biomass feed material. Start-up of the vessel is similar to that of any complex high-temperature processing system and would be evident to skilled artisans in the thermal processing industry once aware of the present disclosure. The main steps are: (1) start the gas turbine on natural gas or biogas to generate electricity or using renewable electricity from the power grid; (2) gradually heat up the vessel by using a renewable gas or biogas burner (this is done primarily to maximize the lifetime of the refractory material by minimizing thermal shock) and switch to plasma torches once suitable inner temperatures are reached; and (3) start the syngas clean-up system with the induced draft fan started first. The consumable molten lava or catalyst bed is then created by adding the material such that a bed is formed. The bed will initially start to form at the bottom of the vessel, but as that initial biochar catalyst, which is closest to the torches, is consumed, the bed will eventually be formed as a layer above the plasma torches at or near the frustoconical portion of the gasifier.

Biomass or other feed materials can then be added. For safety reasons, the preferred mode of operation is to limit the water content of the biomass to less than 5% until a suitable biomass bed is formed. The height of both the consumable catalyst bed and the operating biomass bed depends upon the size of the gasifier, the physico-chemical properties of the feed material, operating set points, and the desired processing rate. However, as noted, the preferred embodiment maintains the consumable catalyst bed above the level of the plasma torch inlets.

Steady-State Operation

When both the biomass bed and the catalyst bed reach the desired height, the system is deemed ready for steady operation. At this time, the operator can begin loading the mixed waste feed from the plant into the feeding system, which is set at a pre-determined throughput rate. The independent variables are also set at levels based on the composition of the biomass feed as pre-determined. The independent variables in the operation of the systems described herein are typically:

A. Plasma Torch Power

B. Gas Flow Rate

C. Gas Flow Distribution

D. Bed Height of the Biomass and Catalyst

E. Feed Rate of the Biomass

F. Feed Rate of the Catalyst

During the steady state, the operator typically monitors the dependent parameters of the system, which include:

A. Exit Top Gas Temperature (measured at exit gas outlet)

B. Exit Top Gas Composition and Flow Rate (measured by gas sampling and flow meter at outlet described above)

C. Slag Melt Temperature and Flow Rate

D. Slag Leachability

E. Slag Viscosity

During operation and based on the above described principles, the operator may adjust the independent variables based upon fluctuations of the dependent variables. This process can be completely automated with pre-set adjustments based on inputs and outputs of the control monitors of the gasifier programmed into the DCS system of the vessel and the whole plant. The pre-set levels are normally optimized during the plant commissioning period when the actual biomass feed is loaded into the systems and the resultant exit top gas and slag behavior are measured and recorded. The DCS will be set to operate under steady state to produce the specific exit gas conditions and slag conditions at specified biomass feed rates. Variations in feed biomass composition will result in variations of the monitored dependent parameters, and the DCS and/or operator will make the corresponding adjustments in the independent variables to maintain steady state. An Artificial Intelligence based algorithm is introduced into the DCS system in order to collect and utilize the data and information collected during the operations of the systems including upset conditions to adopt into the system's standard operating conditions to optimize the plant continual performance and avoid future problems.

Cooling and Scrubbing of the Exit Top Gas from the Plasma Gasifier

As mentioned above, one objective for the operation of the system is to produce a syngas with specific conditions (i.e., composition, calorific heating value, volume and purity and pressure of the renewable hydrogen) suitable for feeding into a plurality of industrial applications, including but not limited to gas turbine for production of renewable electrical energy, Fischer-Tropsch synthesis for production of transportation liquid fuels, production of renewable synthetic methane, combined heat and power system for production of high quality heat for cement kiln, used as high purity hydrogen for fuel cell vehicles, blended as renewable green hydrogen to decarbonize the natural gas pipeline or natural gas power plants, use the renewable hydrogen as reducing agent for Direct Reduced Iron in Steel mills, and finally as large storage of renewable hydrogen for use as renewable energy storage to balance the grid both in short term or in long seasonal storage.

Because the syngas is generated by the pyrolysis of organic biomass material through the process described herein, there will exist certain amounts of biomass impurities, particulates and/or acid gases which are not suitable to the normal and safe operation of these systems. Procedures to clean the exit gas are described in the above mentioned Solena patents.

In view of the present disclosure that describes the current best mode for practicing the invention, many modifications and variations would present themselves to those of skill in the art without departing from the scope and spirit of this invention. All changes, modifications, and variations coming within the meaning and range of equivalency of the claims are to be considered within their scope.

All publications, patents and patent applications cited in this specification are herein incorporated by reference, and for any and all purpose, as if each individual publication, patent or patent application were specifically and individually indicated to be incorporated by reference. In the case of inconsistencies, the present disclosure will prevail.

The foregoing description of the disclosure illustrates and describes the present disclosure. Additionally, the disclosure shows and describes only the preferred embodiments but, as mentioned above, it is to be understood that the disclosure is capable of use in various other combinations, modifications, and environments and is capable of changes or modifications within the scope of the concept as expressed herein, commensurate with the above teachings and/or the skill or knowledge of the relevant art.

The embodiments described hereinabove are further intended to explain best modes known of practicing it and to enable others skilled in the art to utilize the disclosure in such, or other, embodiments and with the various modifications required by the particular applications or uses. Accordingly, the description is not intended to limit it to the form disclosed herein. Also, it is intended that the appended claims be construed to include alternative embodiments. Each of the claims defines a separate invention, which for infringement purposes is recognized as including equivalents to the various elements or limitations specified in the claims.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

1. A method for producing high purity hydrogen and carbon black comprising the use of a pyrolysis system, wherein the pyrolysis system comprises the use of a reactor capable of operating under pyrolytic conditions without the use of oxidizing agents, wherein the pyrolysis system comprises:
(1) primary tuyeres for introducing natural gas into a molten lava bed such that the natural gas is instantly cracked and separated into gaseous hydrogen and carbon black,
(2) plasma torches for introducing inert gas, such as nitrogen or carbon dioxide, to produce a plasma plume,
wherein the hydrogen rises through the molten lava bed into the reactor and exits at the top of the reactor as exit gas, and wherein the exit gas is cooled, compressed, separated and purified; and
wherein the carbon black rises to the top of the lava bed and is collected.

2. The method of claim 1, wherein high purity hydrogen comprises turquoise hydrogen, blue hydrogen, green, white hydrogen and/or combinations thereof.

3. The method of claim 1, wherein the gaseous hydrogen also includes inert gas, including but not limited to, nitrogen and carbon dioxide.

4. The method of claim 1, wherein the reactor does not contain secondary or tertiary tuyeres.

5. The method of claim 1, wherein the molten lava bed comprises silicate-based materials optimized to produce a molten lava bed having desired temperature and viscosity.

6. The method of claim 1, wherein the molten lava bed does not contain any metallic materials and is maintained by plasma torch plumes concentrically placed around the base of the reactor.

7. The method of claim 6, wherein 1-3, 1-4, 1-5, 1-6, or 3 plasma torch plumes are placed around the base of the reactor.

8. The method of claim 1, wherein carbon black includes but is not limited to carbon graphite, acetylene black, channel black, furnace black, lamp black or thermal black.

9. The method of claim 1, wherein 1-3, 1-4, 1-5, 1-6, or 1 primary tuyere(s) are used to introduce natural gas into the molten lava bed.

10. The method of claim 1, wherein the natural gas comprises purified clean methane.

11. The method of claim 1, wherein the primary tuyeres are used to inject natural gas underneath the molten lava bed.

12. The method of claim 1, wherein the exit gas is cooled, compressed, separated and purified using a pressure swing absorber system.

13. The method of claim 1, wherein the carbon black may be separated outside the reactor when the molten materials are cooled and hardened.

14. The method of claim 5, wherein the silicate molten materials are recycled.

15. A method for producing high purity hydrogen and carbon black comprising the use of a plasma pyrolysis system, wherein the pyrolysis system comprises the use of a reactor capable of operating under pyrolytic conditions without the use of oxidizing agents, wherein the pyrolysis system comprises:
(1) primary tuyeres for introducing methane into a molten lava bed such that the methane is instantly cracked and separated into gaseous hydrogen and carbon black,
(2) plasma torches for introducing inert gas, such as nitrogen or carbon dioxide, to produce a plasma plume
wherein the hydrogen rises through the molten lava bed into the reactor and exits at the top of the reactor as exit gas, and wherein the exit gas is cooled, compressed, separated and purified; and wherein the carbon black rises to the top of the lava bed and is collected.

16. The method of claim 15, wherein the methane undergoes pyrolysis in a reducing environment at temperatures greater than 3000 degrees Celsius.

17. The method of claim 15, wherein high purity hydrogen comprises turquoise hydrogen, blue hydrogen, green, white hydrogen and/or combinations thereof.

18. The method of claim 15, wherein high purity hydrogen comprises turquoise hydrogen, and wherein the carbon black comprises carbon graphite.

19. The method of claim 15, wherein feedstock supplied to the system comprises biomass including, but not limited to, waste, re-cycled paper, organic waste, purposely grown energy crops, wood or forest residues, waste from food crops, horticulture, food processing, animal farming, human waste from sewage plants or industry waste.

20. The method of claim 15, wherein the plasma pyrolysis system resembles the system shown in FIG. 1.
